(19) United States
(12) Patent Application Publication
(10) Pub. No.: US 2011/0064218 A1
(43) Pub. Date: Mar. 17, 2011

(54) METHOD, APPARATUS AND SYSTEM FOR ANTI-PIRACY PROTECTION IN DIGITAL CINEMA

(76) Inventor: Donald Henry Willis, Indianapolis, IN (US)

(21) Appl. No.: 12/736,774

(22) PCT Filed: May 15, 2008
(86) PCT No.: PCT/US2008/006232

§ 371 Date: Nov. 8, 2010

(51) Int. Cl. H04N 5/913

(52) U.S. Cl. 380/210

(57) ABSTRACT

A digital cinema anti-piracy system includes a modulator configured to convert an input signal to a desired disruptive frequency and to analyze a brightness, B, of each input pixel in an input frame of the signal, the modulator for determining at least the amount of brightness Bj of each pixel to be displayed in each frame j of a set of N frames, wherein the average of all the brightness values Bj in the N set of frames is substantially equal to B, and N is substantially equal to the number of frames output for each input frame. A brightness of a pixel in a second region Bf(j) can be displayed ‘out of phase’ with the brightness Bj to create a disruptive effect which is distinguishable from the first flicker effect.

### FIELD OF THE INVENTION

The present invention generally relates to content security, and more particularly, to a method, apparatus and system for providing anti-camcorder content for digital cinema media.

### BACKGROUND OF THE INVENTION

Piracy concerns in connection with the theatrical exhibition of motion picture films are well known. For example, in the regular course of exhibiting the film, a customer in the theater may surreptitiously record the film using, e.g., a hand held camcorder. To date, piracy of movie content due to illegal recording is estimated to cost billions in lost revenue.

Current methods of protecting the content include: 1) transmitting patterns in the near-IR spectrum, and 2) modifying the content intended for Digital Cinema projectors to implement visible light anti-camcorder methods.

The first method of a system for protection of movie content (both film and digital) is the method of transmitting near IR images to the screen. The near-IR images may be sensed by a camcorder device, but are not visible to the naked eye. In addition, there is also proposed a system including infrared sensors which senses whether an anti-camcorder system is being used and reports non-usage of the system to assist in enforcement and reporting of an anti-piracy system. While this system is independent of the projection method, the weakness of this system is its reliance on near-IR transmission, for which it is speculated that the use of a specialized near IR filter would render this technique less effective than required for content protection. That is, while one advantage of the near-IR method is that it is display independent, it is speculated that specialized near-IR filters for camcorders might render this technique less than effective.

The second method of modifying the content intended for Digital Cinema projectors is based on the fact that the human eye is not a sampling system whereas a camcorder system is. It proposes high temporal frequency displays which can be modulated with an interfering frequency. Thus, by transmitting frames at other than the standard of 24 Hz, one can take advantage of aliasing and produce various beating patterns in the passband of the camcorder invisible to the naked eye. In addition to modulating the luma of the visible signal, one can also modulate the chroma of the visible signal, and still not be visible.

In addition, others have proposed display blanking intervals that are variable in phase to produce moving or still patterns. However, the above methods are difficult to accomplish in a Digital Light Processing (DLP) display. Still others have proposed multiple primaries chosen to be incompatible with camcorders. This is also difficult and may not work well.

Accordingly, a method, apparatus and system for preventing unauthorized piracy of movie content which avoids the limitations and deficiencies of the previous solutions is highly desirable.

### SUMMARY OF THE INVENTION

The system and method described herein is applicable to digital cinema projection techniques. The term “anti-piracy content” or “anti-sampling system content” used herein may comprise, for example, content used to thwart camcorders or any other video sampling system used to record content displayed/projected on-screen.

According to one embodiment, a system and method for disrupting an unauthorized sampling system (e.g., camcorder) recording of displayed movie content is provided wherein a ‘disruptive’ display frequency which is capable of producing a disruption (e.g., a brightness flicker) in the unauthorized recorded content is selected. In one embodiment, this disruption may be applied to a selected first set or region of pixels. The actual display frequency comprises a multiple N of the selected disruptive display frequency. For example, N=the number of output frames that is displayed per input frame. To illustrate, in one example where the multiple N=2, pixels of low brightness less than 1/N^{th} (e.g., if N=2, then 50%) of maximum brightness) will be displayed in every Nth frame, resulting in the disruptive display frequency.

Additional anti-piracy content in the form of, for example, a message or other disruptive pattern (a ‘second disruption’) can further be provided in the displayed image by modulating the brightness in different frames of the every-Nth-frame in a second selected set of pixels. Accordingly, this causes differences in the amount of brightness of the first set of pixels and the second set of pixels as captured by a camcorder, thus making the pattern/message of the second set of pixels visible in a video recording.

Advantageously, a system and method according to embodiments of the present invention provide resultant displayed movie images which include anti-piracy content that is virtually invisible to the naked human eye, yet effective in preventing a useful video sequence from being recorded by a camcorder or other video camera device during playing of the movie. In addition, the anti-piracy content can include a customizable message clearly readable in the pirated content indicating, for example, the theater location, origination, time of presentation, etc., so as to perform effective ‘fingerprinting’ of the pirated content.

In one embodiment of the present invention, a digital cinema anti-piracy system is provided comprising a modulator configured to convert an input signal to a desired disruptive frequency and to analyze a brightness B of each input pixel in an input frame of the signal, the modulator for determining at least the amount of brightness Bⱼ of each pixel to be displayed in each frame j of a set of N frames, wherein the average of all the brightness values Bⱼ in the N set of frames is substantially equal to B, and N is substantially equal to the number of frames output for each input frame.

According to another embodiment, a method for providing anti-piracy content for digital cinema is provided comprising the steps of determining at least one pixel region in an input frame, determining a multiple N of a desired sampling system disruptive frequency, analyzing the brightness B of each pixel in the frame, and determining at least the amount of brightness Bⱼ of each pixel to be displayed in each frame j of a set of N frames, wherein the average of all the brightness values Bⱼ in the N set of frames is substantially equal to B, and N is substantially equal to the number of frames output for each input frame.

### BRIEF DESCRIPTION OF THE DRAWINGS

The teachings of the present invention can be readily understood by considering the following detailed description in conjunction with the accompanying drawings, in which:

FIG. 1 depicts a high level block diagram of an exemplary system for providing anti-piracy digital cinema content in accordance with an embodiment of the present invention;

FIG. 2 depicts an exemplary illustration of a temporal waveform showing how a pixel's brightness is displayed in display frames to achieve a disruptive effect in a first region in accordance with an embodiment of the present invention;

FIG. 3 depicts an exemplary illustration of a temporal waveform showing how the brightness of the pixel of FIG. 2 is displayed in display frames in a portion of a transition region in accordance with an embodiment of the present invention;

FIG. 4 depicts an exemplary illustration of a temporal waveform showing how a pixel's brightness is displayed in display frames to achieve a disruptive effect in a second region in accordance with an embodiment of the present invention;

FIG. 5 depicts an exemplary illustration of a temporal waveform showing how the brightness of the pixel of FIG. 4 is displayed in display frames in a portion of a transition region in accordance with an embodiment of the present invention;

FIG. 6 depicts an exemplary illustration of the waveform of FIG. 1 superimposed with the waveform of FIG. 4 with respect to display frame intervals and exemplary video capture intervals in accordance with an embodiment of the present invention;

FIG. 7 depicts an exemplary illustration of a temporal graph showing the relative brightness levels of the pixels of FIG. 6 as captured by a video camera with respect to the video capture intervals in accordance with an embodiment of the present invention;

FIG. 8 depicts an exemplary depiction of various pixel regions and a transition region in a frame in accordance with an embodiment of the present invention;

FIG. 9 depicts a flow diagram of an exemplary method for providing anti-piracy digital cinema content in accordance with an embodiment of the present invention;

FIG. 10 depicts a flow diagram of an exemplary method for providing anti-piracy digital cinema content for a pixel in a second region of a frame in accordance with an embodiment of the present invention; and

FIG. 11 depicts a flow diagram of an exemplary method for creating a transition effect between a first and second region of a frame in accordance with an embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

Embodiments of the present invention provide a method, apparatus and system for providing anti-piracy content for digital cinema. Although the present principles will be described primarily within the context of a specific digital cinema system, the specific embodiments of present principles should not be treated as limiting the scope of the invention. It will be appreciated by those skilled in the art and informed by the teachings of the present principles that the concepts of the present principles can be advantageously applied in other environments in which anti-piracy content is desired.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

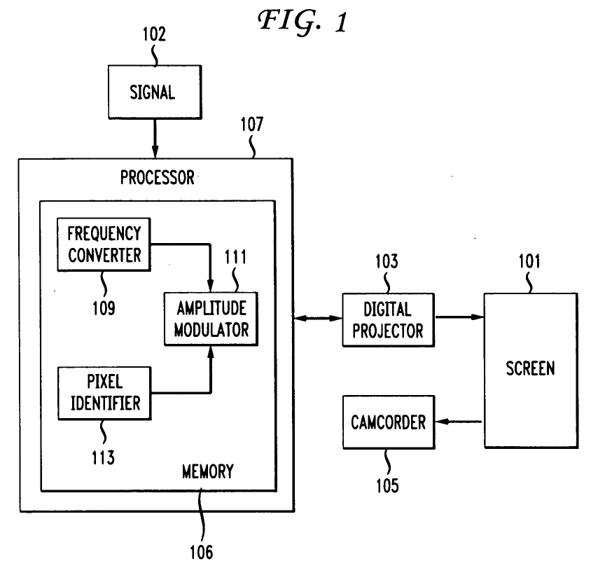

FIG. 1 depicts a high level block diagram of an exemplary system for providing anti-piracy digital cinema content in accordance with an embodiment of the present invention. The system of FIG. 1 illustratively includes a digital projector 103 for projecting image content (e.g., movie images) onto a screen 101. A camcorder 105 can be oriented with respect to the screen 101 so as to record any content displayed thereon. It is to be noted that the system components herein described can further include conventional components of a Digital Cinema projection system, which are well known in the art and not described herein.

According to the embodiment of the present invention of FIG. 1, a modulator 107 is provided in communication with the projector 103. Although in the embodiment of FIG. 1, the modulator 107 is depicted as a separate device, in alternate embodiments of the present invention, the modulator can be an integrated component of the projector 103, and can further include at least a memory 106 for storing, for example, software configured to carry out the processing steps described herein. The modulator 107 can further include a frequency converter 109 for converting an input signal 102 into a desired disruptive frequency (e.g., 55 Hz). The memory 106 can, as such, be used to store the calculated output of frames.

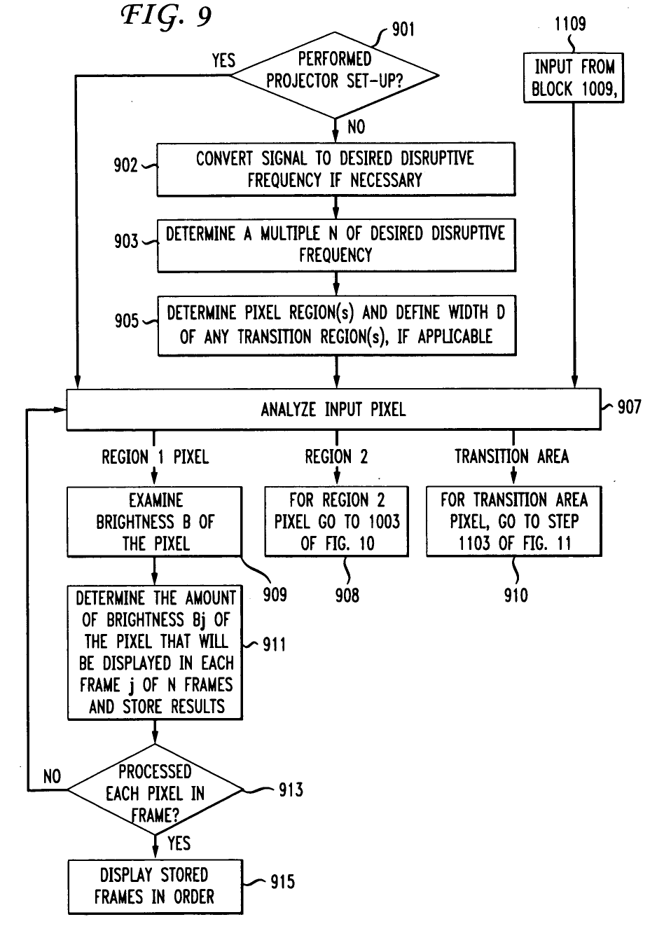

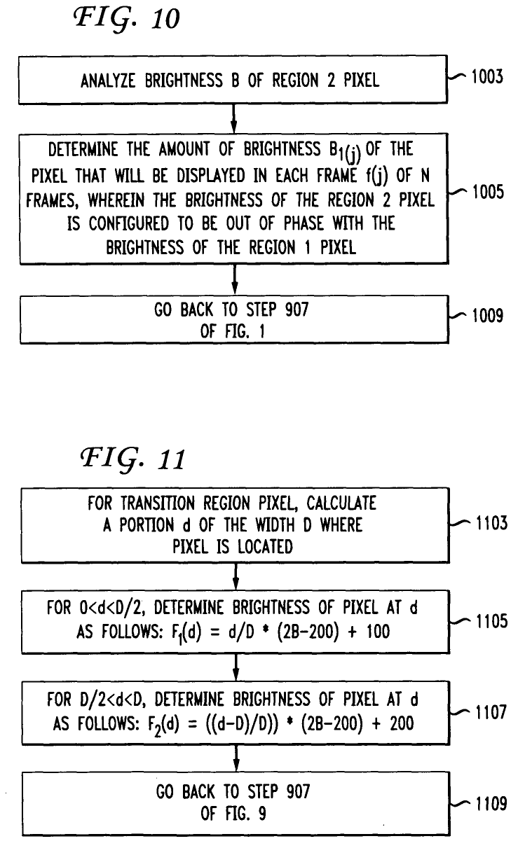

The modulator 107 can further include a pixel identifier 113 for determining on which region (e.g., Region 1, Region 2, or a transition region) of a frame the pixel is located. The modulator 107 can further include an amplitude modulator 111 configured to provide modulated brightness values, Bⱼ, of each selected pixel in accordance with a determined multiple, N, of a desired disruptive frequency and relative to a brightness, B, of each pixel. In various embodiments of the present invention, the amplitude modulator 111 can also function as a frame repeater. For example, the amplitude modulator 111 can be configured to perform the steps of the processes as described in FIGS. 9-11, below. These components, for example, the amplitude modulator and frequency converter, can be implemented in hardware, as circuits for example, or in software.

The modulator 107 can further include a database (not shown) for storing, for example, anti-piracy content in the form of pre-determined images, letters, numbers, designs, logos, etc., for creating identifiable messages in pirated content. Such messages can inform a viewer of the pirated material of the origins, location, nature, etc. of the pirated material. Such database can also be externally provided on a server accessible via a network (e.g., the Internet). In various embodiments of the present invention, the amplitude modulator 111 can further include the ability to create new or customized anti-piracy content.

For example, according to an aspect of the present invention, anti-sampling system content can comprise modulated visible light, wherein the luma value (quantity representative of luminance information) of each pixel is temporally modulated. Such modulation is virtually invisible to the naked human eye, yet readily detectable on a recording of modulated content made by a sampling system such as a camcorder.

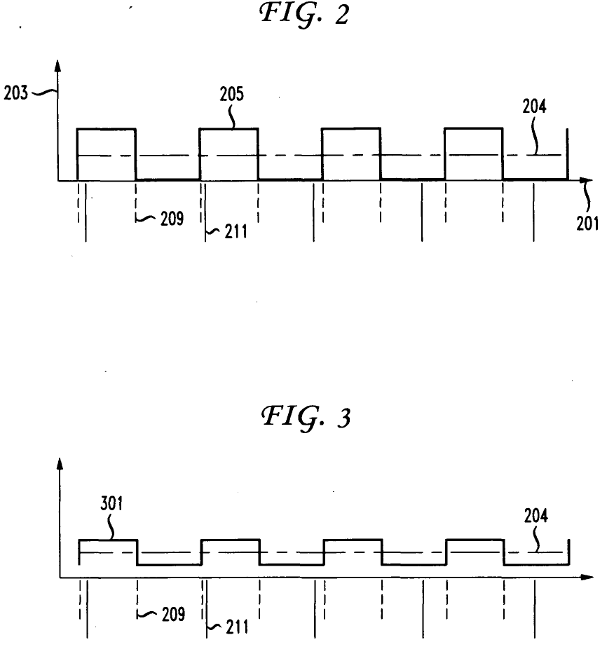

Camcorders typically operate on a few discrete temporal frequencies (e.g., 60 Hz, 50 Hz, 24 Hz, etc). According to an embodiment of the present invention, a digital cinema system is provided which is arranged to operate on a different frequency than a camcorder frequency, which causes a disruptive flicker to appear in the camcorder recording. Thus, a “normal” digital cinema display (e.g., at 110 Hz) using effectively a 100% duty cycle which is caused to operate at a multiple, N, of the disruptive different frequency, can be implemented to disrupt camcorder recording. For example, for a multiple N=2, if the brightness of a particular pixel in a first region (‘Region 1’) incoming frame is less than 50%, double of that pixel's light can be displayed in every other frame with in-between frames displaying zero brightness. This is depicted by square wave 205 in the graph of FIG. 2, to be described in further detail below.

N is defined as the number of times each frame gets displayed. That is, an N number of frames are displayed within substantially the same amount of time as one input frame, such that N is substantially equal to the number of frames output for each input frame.

In the same example where multiple N=2, pixels having a brightness level greater than 50% will result in maximum brightness every other frame, with some additional brightness in the in-between frames. That is, if the brightness of a pixel is greater than 50%, then the maximum brightness (100%) is displayed every other frame, with in-between frames displaying some level of brightness greater than zero (which is determined according to the value between 50 and 100%).

Advantageously, this results in an effective display frequency of a disruptive frequency (e.g., 55 Hz) in combination with a duty cycle of 50%. While such displayed content will appear normal to the human viewer, a recording of such modulated displayed content made by a camcorder or other sampling system device would exhibit a disruptive ‘flicker’ effect, thus rendering the recording useless.

In accordance with various embodiments of the present invention, anti-piracy capability can be included which can assist in tracking, identifying, ‘fingerprinting’, etc., the digital cinema movie content. That is, in accordance with various embodiments of the present invention, a customized “message” or other additional discernable pattern is added to the content such that is becomes visible and readily identifiable in a camcorder recording. That is, a separate region(s) (e.g., ‘Region 2’) in the frame is selected for carrying a ‘message.’ For pixels in the pattern/message, any light is displayed during the in-between frames of the Region 1 pixels. This creates flicker in the camcorder recording in the Region 2 areas of each frame which is out of phase with the Region 1 flicker, thus making the message/pattern of Region 2 clearly visible and identifiable in the camcorder recording.

To reduce the probability that the added message/pattern might be visible to a human viewer, the out-of-phase message/pattern of Region 2 can be reduced in contrast with the ‘background’ Region 1 by, in one embodiment, “feathering” the edges of the message/pattern so as to transition the level of light displayed between Region 1 to Region 2. That is, in accordance with embodiments of the present invention a transition region can be created between Region 1 and Region 2 which gradually changes over from having light in one set of frames (e.g., Region 1) to having light in the other set (e.g., Region 2).

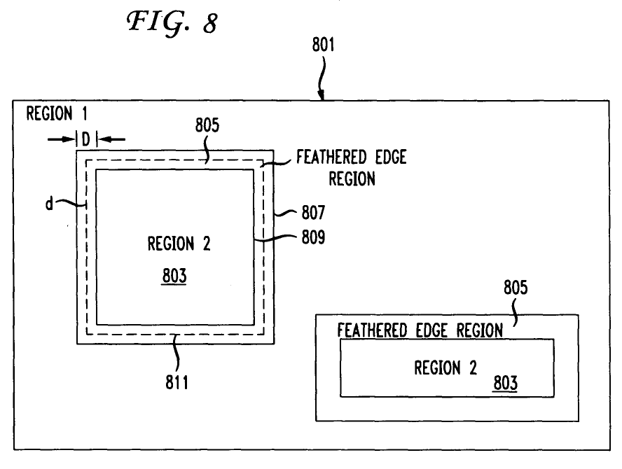

FIG. 2 depicts an exemplary illustration of a temporal waveform showing how a pixel's brightness is displayed in display frames to achieve a disruptive effect in a first region having a multiple, N=2 and the brightness of the pixel<50% of maximum in accordance with an embodiment of the present invention. In FIG. 2, a temporal diagram of the display periods 209 on the same scale as a camcorder capture intervals 211 and the modulation of pixels which have a brightness B<50% of maximum are illustrated. Further, the example of FIG. 2 is a graphical illustration of the modulation performed using the multiple N=2 of the disruptive frequency. In the embodiment of FIG. 2 in which N=2, one input frame is equal to two output frames, and there is no movement in the scene. In addition, in the embodiment of FIG. 2, it should be noted that the display frequency is a little less than twice the camcorder frequency. A set of pixels in a first region (region 1) of the display, represented by the solid square wave 205, can be considered ‘Pixel set 1’ or ‘Region 1.’ For example, as shown in FIG. 8, region 1 (801) can comprise a major portion of a display frame area.

Referring to FIGS. 2-5, it is to be noted that a flat line waveform 204 is depicted for exemplary purposes to represent instances in which there is no fluctuation of brightness levels, and thus no flickering effect is produced.

In cases in which the brightness level of the pixels is below 50% of maximum, Pixel set 1 is displayed in the display frames 209 as shown by the solid square wave. That is, the brightness is fluctuated from a level that is two times the actual pixel brightness to zero brightness in every other frame. To illustrate, for a pixel in Region 1 having a brightness of 40%, the brightness would be modulated and output as shown in Table 1, below.

TABLE 1

| | Frame 1 | Frame 2 | Frame 3 | Frame 4 | Frame 5 | Frame 6 . . . |
|---|---|---|---|---|---|---|
| Pixel | 80% | 0% | 80% | 0% | 80% | 0% |
| set 1: | | | | | | |

The example in Table 1 is depicting an input signal in a scene in which there is no motion, and Frame 1 and Frame 2 comprise two output frames created from one input frame. Thus, for the example where N=2, each pixel is effectively displayed at half the main display frequency, which causes a disruptive flicker in a camcorder recording.

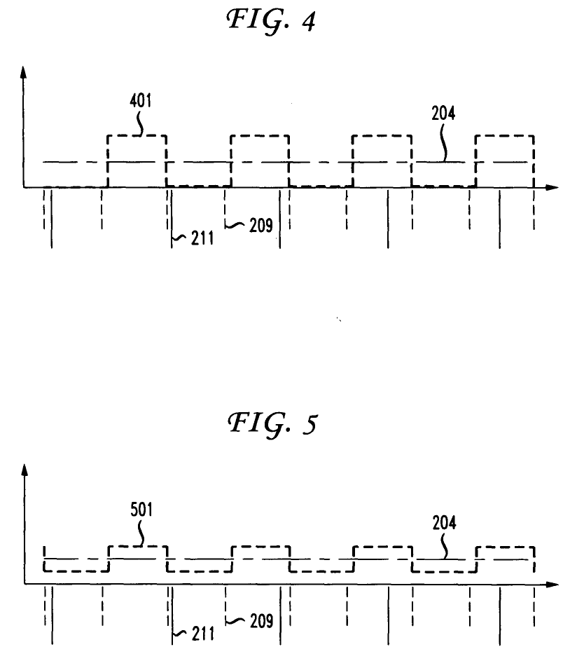

FIG. 4 depicts an exemplary illustration of a temporal waveform showing how a pixel's brightness is displayed in display frames to achieve a disruptive effect in a second region having a multiple N=2 and the brightness of the pixel<50% of maximum in accordance with an embodiment of the present invention. In FIG. 4, another set of pixels, Pixel set 2, or ‘Region 2’ as indicated by the broken-line square wave 207 on the graph, can comprise a separate region(s) of the display (e.g., Region 2) to display a message. For example, as shown in FIG. 8, Region 2 (803) can comprise a smaller total area than that occupied by Region 1 (801).

To generate the out-of-phase flicker, Pixel set 2 is displayed in the display frames as shown by the broken-line square wave 401 of FIG. 4. For example, for a pixel in Region 2 having a brightness of 40%, its brightness is modulated and output in alternating frames with respect to the Pixel set 1 as shown in Table 2, below.

TABLE 2

| | Frame 1 | Frame 2 | Frame 3 | Frame 4 | Frame 5 | Frame 6 . . . |
|---|---|---|---|---|---|---|
| Pixel | 80% | 0% | 80% | 0% | 80% | 0% |
| set 1: | | | | | | |
| Pixel | 0% | 80% | 0% | 80% | 0% | 80% |
| set 2: | | | | | | |

Accordingly, in both Regions 1 and 2 and in the case where N=2, each pixel is effectively displayed at half the main display frequency, thus causing disruptive flickering in a camcorder recording of the modulated content.

The above described example in which the actual display frequency is a multiple N=2 of the disruptive frequency, and in which two regions (Region 1 and Region 2) are selected is an exemplary embodiment. For example, where the actual display frequency=110 Hz, the disruptive frequency=55 Hz and the flicker induced in a 60 Hz camcorder=5 Hz.

However, it is to be noted that the timing of the display of each pixel's light can be altered such that the actual display frequency can comprise any multiple N (e.g., N=3, 4, 5 . . . etc.). Depending on whether N comprises an even or odd integer, a different formula is applied to produce the desired ‘out-of-phase’ effect, as shown below. However, regardless of the value of the multiple N that is selected, the average brightness output over the total of N frames is not changed, and thus, the overall light levels of the image content appears unchanged to the human eye. That is, where B=brightness of an incoming pixel, and Bⱼ=brightness of incoming pixel in display frame j in a group of N frames to be displayed, the average of all the brightness values Bᵢ is substantially equal to B. For example:

(B₁+B₂+ . . . B_{N})/N=B

At the same time, a modulation technique in accordance with various embodiments of the present principles provides effective and disruptive anti-piracy flickering effects in any video recording made of the display.

Exemplary formulae which can be used for determining specific amounts of brightness to be output, for example, in Region 1 and Region 2 for each frame Bⱼ and B_{f(j)}, respectively, of N frames are described as follows:
B=brightness of incoming pixel
N=multiple (number of frames as a multiple of the interfering frequency)
Bⱼ=brightness of incoming pixel in display frame j in a group of N frames to be displayed during a frame period of the incoming signal.
For all displayed frames, the maximum brightness is 100, representing 100% of the brightness capability of the display.

To Implement the Method for a Pixel in Region 1:
B₁=N*B, (to a maximum of 100)
B₂=((N*B)−B₁), (again, max of 100)
. . .
Bⱼ=(N*B)−sum(Bₓ), where x=[1 to (j−1)],
   wherein “sum( )” is the summation function.

For a Pixel in Region 2:

$${B}_{f ( j )} = ( {N}^{*} B ) - sum ( {B}_{x} ) , \\ where$$

$$x = [ 1 to ( j - 1 ) ] , \\ where$$

$$\begin{matrix}f ( j ) = modulo N ( N / 2 + j ) for even integers N \\ = modulo N ( N / 2 + .5 + j ) for odd integers N\end{matrix}$$

FIG. 3 depicts an exemplary illustration of a temporal waveform showing how the brightness of the pixel of FIG. 2 is displayed in display frames in a portion of a transition region, in accordance with an embodiment of the present invention.

That is, FIG. 3 depicts an exemplary representation of a temporal light waveform in one portion of the transition region and corresponding to the pixel represented by waveform 205 where multiple N=2. In the area of the transition region depicted by FIG. 3, the pixel has brightness/light in every frame (the waveform does not go to zero in any of the frames), The proportion of light changes as you get further away from one pixel region and into the other.

Similarly, FIG. 5 depicts an exemplary illustration of a temporal waveform showing how the brightness of the pixel of FIG. 4 is displayed in display frames in a portion of a transition region, in accordance with an embodiment of the present invention.

FIG. 8 depicts an exemplary depiction of a region 1 (801), a region 2 (803) and transition regions 805 in a frame in accordance with an embodiment of the present invention. The transition or feathered edge region 805 comprises an area where there is a transition or gradual change in the levels of brightness between each different pixel region, e.g., pixel region 1 (801) and pixel region 2 (803). The creation of a transition region advantageously reduces the possibility that the anti-sampling system content will cause undesirable side effects that would be visible to a human viewer (e.g., flickering, flashes, etc.) while maintaining the maximum desired negative effect on any pirated recording.

With reference to FIG. 8, pixel located along an outer edge 807 of the transition region 805 can be represented by a temporal light waveform corresponding to solid-line square wave 205 of FIG. 2. A pixel located along an inner edge 809 of the transition region 805 can be represented by a temporal light waveform corresponding to broken-line square wave 207 of FIG. 2. A pixel located along a midpoint 811 of the transition region 805 can be represented by a temporal light waveform corresponding to the flat line wave 204 of FIG. 2.

A pixel located in an area of the transition region 805 between the outer edge 807 and midpoint 811 can have a waveform similar or closer to the solid line wave 301 in FIG. 3, whereas a pixel located in an area between the midpoint 811 and the inner edge 809 can have a temporal light waveform similar or closer to the broken-line square wave 501 in FIG. 5. That is, for a given pixel having the same brightness, the peak-to-peak (AC) value of the brightness will gradually decrease going from Region 1 (801) to the midpoint 811 of Region 2. At the midpoint 811, the AC component=0 (represented by flat line waveform 204). From the midpoint 811 to Region 2 (803), the AC component will gradually increase. It should be noted that the average brightness value (DC value) of all of the waveforms will remain constant, and thus the overall light output is not altered.

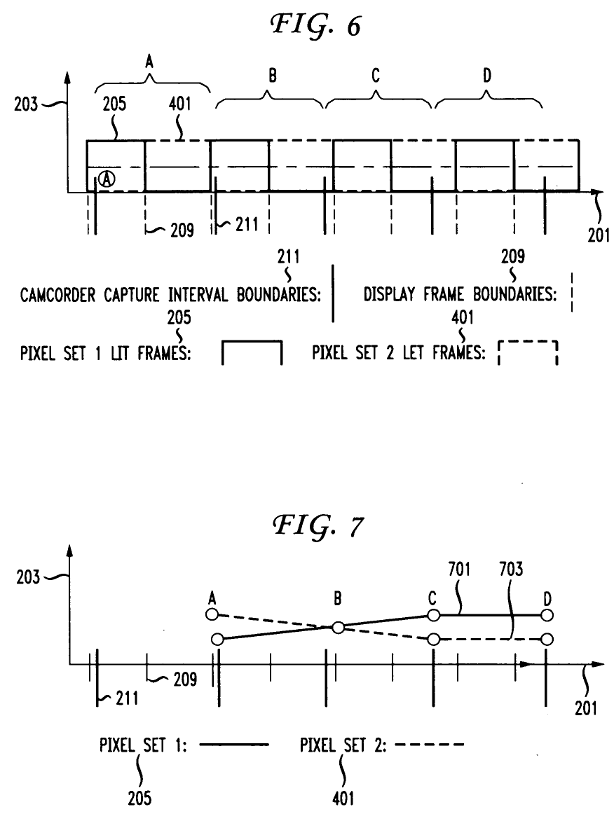

FIG. 6 depicts an exemplary illustration of the Region 1 waveform 205 of FIG. 2 superimposed with the Region 2 waveform 401 of FIG. 4 with respect to display frame intervals and exemplary video capture intervals in accordance with an embodiment of the present invention. As can be seen, for a pixel in Region 2, any light is displayed during the ‘in-between’ frames of the Region 1 pixel. This creates flicker in the camcorder recording in the Region 2 areas of each frame which is out of phase with the Region 1 flicker, thus making the message/pattern of Region 2 clearly visible and/or detectable in a video recording.

FIG. 7 depicts an exemplary illustration of a temporal graph showing the relative brightness levels of the pixels of FIG. 6 as captured by a video camera with respect to the video capture intervals in accordance with an embodiment of the present invention. That is, FIG. 7 shows the resultant disruptive effect on a camcorder. For exemplary and illustrative purposes only, the examples depicted in FIGS. 6 and 7 depict an instance in which the disruptive frequency is less than the camcorder capturing frequency. For example, the graphs of FIGS. 6 and 7 represent an instance in which the disruptive frequency is 55 Hz, the camcorder capture frequency is 60 Hz and the display frequency is 110 Hz.

FIG. 7 shows the relative brightness levels of the pixels 205, 401 of FIG. 6 as captured by a video camera recording the displayed on-screen content with respect to the video capture intervals A, B, C, D of FIG. 6 in accordance with an embodiment of the present invention. In the camcorder recording, the Region 1 pixel will have a brightness 203 versus time 201 as shown by the solid curve 701. The Region 2 pixel will have a brightness 203 versus time 201 as shown by the broken line curve 703. Points A, B, C, D in FIG. 7 correspond to the brightness captured during intervals A, B, C, D, respectively, in FIG. 6. Again, it can be seen that the curves are out of phase, thus making the pattern of the Region 2 pixel visible in the camcorder recording.

FIG. 9 depicts a flow diagram of an exemplary method for providing anti-piracy digital cinema content in accordance with an embodiment of the present invention. The method of FIG. 9 begins in step 901, in which it is determined whether a set up procedure for the digital projector has been performed. If yes, the method jumps to step 907. If no, the method proceeds to step 902.

In step 902, an incoming signal 102 can be converted to the desired disruptive frequency. The method then proceeds to step 903.

In step 903 a multiple N of the desired disruptive frequency is selected. The method then proceeds to step 905.

In step 905, at least one pixel region(s) within each frame is determined. However, it should be noted that any number of pixel regions can be determined in accordance with various embodiments of the present invention. For example, if a plurality of regions (e.g., Region 1 and Region 2) is determined, than a width D of a transition region may also be determined between the separate regions (e.g., a width D of a transition region between Region 1 and Region 2). The remaining steps are performed individually for each color component (e.g., each primary color, such as RGB) of each pixel of each frame. For example, the method then proceeds to step 907.

In step 907, an input pixel is analyzed, for example, to determine its region location. If the pixel is determined to be located in a Region 1, then the method proceeds to step 909. If the incoming pixel is determined to be in a Region 2, the method proceeds to step 1003 of FIG. 10. If the pixel is determined to be in a transition area, the method proceeds to step 1103 of FIG. 11. The processes of FIGS. 10 and 11 will be described further below.

In step 909, a brightness B of each pixel color component is examined. The method then proceeds to step 911.

In step 911, the amount of brightness, Bⱼ, (e.g., percentage of maximum possible brightness that the display is capable of) of each component of the pixel that is to be displayed in each frame, j, of the N frames is determined. The results can be stored in memory and updated as needed.

The precise amount of brightness, B₁, that is to be displayed in each frame, j, can be determined by the formula provided above with respect to B₁. Advantageously, while the amount of brightness of each frame, j, in the group of N frames is changed thus causing a disruptive flicker effect in a camcorder recording, the overall brightness output for the pixel remains unchanged throughout the display period of at least the group of N frames. Accordingly, overall light levels are unchanged and the human eye will not detect any noticeable difference in picture quality and appearance. The method then proceeds to step 913.

Step 913 is a loop back to step 907 to assure that each pixel of the frame is processed. If all pixels of one of the input frames have been processed, in one exemplary embodiment, the stored frames can be displayed, in order, after all the calculations are completed for one of the input frames in step 915. In alternate embodiments, the first calculated output frame are displayed before all the output pixels for that input frame are calculated, if the calculation can be completed before the display of the Nth display frame is performed.

FIG. 10 is a flow diagram of an exemplary method for providing anti-piracy digital cinema content in a second region of a frame in accordance with an embodiment of the present invention.

The method of FIG. 10 begins in step 1003, in which a brightness B of the region 2 pixel is examined. The method then proceeds to step 1005.

In step 1005, the amount of brightness B_{f(j)} of each component of the pixel in region 2 that is to be displayed in each frame f(j) of the N frames is determined. Preferably, according to one aspect of the present principles, the brightness of the region 2 pixel is determined in each frame f(j) so as to be displayed ‘out of phase’ with the brightness as output for the region 1 pixels. That is, to illustrate using the example where two regions are selected, the pixels in region 2 will be configured to display greater brightness during those display frame intervals in which the pixels in region 1 are displaying a lesser brightness, and vice versa. The precise amount of brightness B_{f(j)} that is to be displayed in each frame j may be determined by the formula provided above with respect to B_{f(j)}. This creates flicker in the camcorder recording in the Region 2 areas of each frame which is out of phase with the Region 1 flicker, thus making the message/pattern of Region 2 clearly visible and/or readable in the recording. The method then proceeds to step 1009.

Step 1009 is a loop back to step 907 to assure that each pixel of the frame is processed.

FIG. 11 is a flow diagram of an exemplary method for creating a transition effect between a first and second region of a frame in accordance with an embodiment of the present invention. The method of FIG. 11 begins in step 1103 in which, for a pixel located in a transition area, a position d is calculated, which comprises the location in the width D where the pixel is located. Referring back to FIG. 8, D is shown as the width of the transition region 805, with d comprising any point in the transition region. That is, in one embodiment of the present invention:
D=width of the transition region,
d=the portion of D where brightness output is desired to be determined.

It should be noted that d and D comprise linear distances. That is, d comprises how far across the width of D the pixel is located.

To calculate the brightness of the pixel located at d, the same formula above apply, except they are solved using a different maximum brightness value (e.g., the maximum is not =to 100). That is:

For the area of transition region 0<d<D/2:
Bⱼ=Bᵢ for region 1 above, except that the maximum of any Bⱼ is not 100 but is F₁(d), wherein:

F₁(d)=(d/D)*(2B−200)+100

For area of transition region D/2<d<D:
B_{f(j)}=B_{f(j)} for region 2 above, except that the maximum of any B_{f(j)} is not 100 but is F₂(d), wherein:

F₂(d)=((d−D)/(D))*(2*B−200)+200.

The method of FIG. 11 then proceeds to step 1109.

Step 1109 is a loop back to step 907 of FIG. 9 to assure that all pixels have been processed.

Having described various embodiments for a method, apparatus and system for providing anti-piracy content for digital cinema (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. While the forgoing is directed to various embodiments of the present invention, other and further embodiments of the invention may be devised without departing from the basic scope thereof.

1. A digital cinema anti-piracy system comprising:
a modulator configured to convert an input signal to a desired disruptive frequency and to analyze a brightness B of each input pixel in an input frame of the signal, the modulator for determining at least the amount of brightness Bⱼ of each pixel to be displayed in each frame j of a set of N frames, wherein the average of all the brightness values Bⱼ in the N set of frames is substantially equal to B, and N is substantially equal to the number of frames output for each input frame.

2. The system of claim 1, further comprising a frequency converter for converting the input signal to the desired disruptive frequency.

3. The system of claim 1, further comprising a pixel identifier for determining at least one region in each frame in which the pixel is located.

4. The system of claim 1, wherein the amount of brightness B; comprises a percentage of the maximum possible brightness of the displayed pixel.

5. The system of claim 3, wherein if the pixel is determined to be in a first region, Bⱼ=(N*B)−sum(Bₓ), where x=[1 to (j−1)].

6. The system of claim 3, wherein if the pixel is determined to be in a second region, the modulator is configured to determine an amount of brightness B_{f(j)} to be displayed in said pixel of the second region in each frame j of the set of N frames, wherein the brightness B_{f(j)} is configured to be displayed out of phase with the brightness Bⱼ.

7. The system of claim 1, wherein the average of all the brightness values B₍ⱼ₎=(B₁+B₂+ . . . B_{N})/N.

8. The system of claim 6, wherein the modulator is configured to create a transition effect in a transition region between the first and the second regions.

9. The system of claim 8 wherein the transition effect comprises a gradual transition in the level of brightness displayed between the first and second regions.

10. A method for providing anti-piracy content for digital cinema comprising the steps of:
determining at least one pixel region in an input frame;
determining a multiple N of a desired sampling system disruptive frequency;
analyzing the brightness B of each pixel in the frame; and
determining at least the amount of brightness Bⱼ of each pixel to be displayed in each frame j of a set of N frames, wherein the average of all the brightness values Bⱼ in the N set of frames is substantially equal to B, and N is substantially equal to the number of frames output for each input frame.

11. The method of claim 10, further comprising converting an input signal to the desired disruptive frequency.

12. The method of claim 10, wherein the amount of brightness B; comprises a percentage of the maximum possible brightness of the displayed pixel.

13. The method of claim 10, wherein if the pixel is determined to be in a first region, further comprising wherein Bⱼ=(N*B)−sum(Bₓ), where x=[1 to (j−1)], wherein Bⱼ has a maximum value of 100.

14. The method of claim 10, wherein if the pixel is determined to be in a second region, the modulator is configured for determining an amount of brightness B_{f(j)} to be displayed in said pixel of the second region in each frame j of the set of N frames, wherein the brightness B_{f(j)} is configured to be displayed out of phase with the brightness Bⱼ.

15. The method of claim 10, wherein the average of all the brightness values B₍ⱼ₎=(B₁+B₂+ . . . B_{N})/N.

16. The method of claim 14, further comprising creating a transition effect in a transition region between the first and the second regions.

17. The method of claim 14, wherein if N comprises an even integer, f(j)=modulo N(N/2+j).

18. The method of claim 14, wherein if N comprises an odd integer, f(j)=modulo N(N/2+0.5+j).

19. The method of claim 16, wherein the step of creating a transition effect further comprises calculating a position d of the transition region in which the pixel is located, wherein for 0<d<D/2, the maximum possible brightness of Bⱼ=(d/D)*(2B−200)+100.

20. The method of claim 16, wherein the step of creating a transition effect further comprises calculating a position d of the transition region in which the pixel is located, wherein for D/2<d<D, the maximum possible brightness of Bⱼ=((d−D/D))*(2B−200)+200.
